(19) United States
(12) Patent Application Publication
(10) Pub. No.: US 2022/0320963 A1
(43) Pub. Date: Oct. 6, 2022

(54) ELECTRIC MACHINE WITH A RADIAL SHAFT SEALING RING

(71) Applicant: Valeo Siemens eAutomotive Germany GmbH, Erlangen (DE)

(72) Inventors: Andreas Dietz, Bad Neustadt a.d.Saale (DE); Philipp Holzheimer, Bad Neustadt a.d.Saale (DE)

(73) Assignee: Valeo Siemens eAutomotive Germany GmbH, Erlangen (DE)

(21) Appl. No.: 17/656,735

(22) Filed: Mar. 28, 2022

(30) Foreign Application Priority Data
Mar. 31, 2021 (DE) 10 2021 203 302.4

(51) Int. Cl. H02K 9/197; H02K 5/20; H02K 9/193; B60K 1/00

(52) U.S. Cl. CPC H02K 9/197; H02K 5/203; H02K 9/193; B60K 1/00; B60K 2001/006

(57) ABSTRACT

An electric machine (1), comprising: a housing (2), in which a stator (3) and a rotor (4), which is rotatable relative to the stator (3), are accommodated, a cooling device with a cooling channel (5) through which a coolant can flow and which extends from an inlet (7), through the housing (2) and through the rotor (4), to an outlet (6), and a sealing device (18) for sealing off the rotor (4) with respect to an interior space (19) of the housing, wherein the sealing device (18) has a radial shaft sealing ring (11) which surrounds the rotor (4) and which delimits a reservoir (12) for coolant leakage. Additionally described are a drivetrain for a vehicle (14) having such an electric machine (1), and a method for operating the electric machine (1).

The invention relates to an electric machine, comprising a housing, in which a stator and a rotor, which is rotatable relative to the stator, are accommodated, a cooling device with a cooling channel through which a coolant can flow and which extends from an inlet, through the housing and through the rotor, to an outlet, and a sealing device for sealing off the rotor with respect to an interior space of the housing.

Electric machines of this type are increasingly used in electrically driven vehicles or hybrid vehicles. Here, the electric machine is used predominantly as an electric motor for driving a wheel or an axle of the vehicle. The electric motor may be configured, inter alia, as a synchronous motor or an asynchronous motor.

The electric motor is normally mechanically coupled to a gearbox for rotational speed adaptation. The electric motor is additionally normally electrically connected to an inverter which, from DC voltage that is provided from a battery, generates AC voltage, in particular multi-phase AC voltage, for the operation of the electric machine.

It is also possible for the electric machine to be operated as a generator for the recuperation of kinetic energy of a vehicle, wherein the kinetic energy is converted firstly into electrical energy and then into chemical energy of the battery.

The rotor of the electric machine normally has a rotor shaft that is enclosed by a cylindrical rotor body. Aside from a stack of laminated metal sheets, the rotor body may have, inter alia, permanent magnets or a winding with an electrical conductor.

Owing to the heat that is generated during the operation of the electric machine, said electric machine has a cooling device for dissipating the heat, which cooling device comprises a cooling channel through which a liquid coolant can flow. The cooling channel extends from an inlet, through the housing of the electric machine and onward through the rotor, to an outlet which is formed in the housing. The coolant, which may for example be a water-glycol mixture, is conveyed in a circuit.

A sealing device seals off the rotor with respect to the housing. In particular, the coolant-filled cooling channel that runs through the rotor is sealed off with respect to an interior space of the housing, such that no coolant can pass from the cooling channel into the interior space and lead to damage there, for example as a result of corrosion. The interior space may accommodate, inter alia, the stator, and may otherwise be filled with air.

The temperature-induced change in volume of the air in the interior of the housing necessitates the provision of aeration and/or ventilation that prevents the generation of a negative pressure or of a positive pressure in the housing. For this purpose, a ventilation channel may be provided which extends from the sealing device to an opening of the housing.

It has been found that, despite the sealing device, an at least small amount of technical leakage of coolant can occur via the sealing device during the operation of the electric machine. This technical leakage (coolant leakage) occurs in particular when the electric machine is operated in a particular direction of rotation.

In the case of a vehicle that is driven using the electric machine, the leakage can occur for example during reverse travel.

It has already been proposed to collect the technical leakage in a reservoir that is separate from the housing of the electric machine, that is to say in a special vessel. Said vessel must however be emptied at certain time intervals during the course of the maintenance of the vehicle, leading to undesired effort and costs.

If the reservoir were instead arranged in the housing, there would be the risk of coolant leakage passing out of the reservoir into an interior space of the machine and causing damage there. The damage could occur through corrosion of the windings of a stator arranged in the interior space.

To solve the problem, it has been proposed to equip a bearing of the rotor of the electric machine with a seal that prevents an ingress of coolant leakage into the interior space. However, the sealing action of such a sealed rotor bearing is insufficient, and coolant leakage can thus nevertheless pass into the interior space.

The risk arises in particular if the coolant leakage vaporizes or evaporates owing to the heat of operation of the electric machine. The coolant leakage thus changes from the liquid state of aggregation into the gaseous state of aggregation, in which the coolant leakage can easily overcome the barrier formed by the sealed rotor bearing.

It is the object of the invention to specify an electric machine that can be operated with lower outlay on maintenance, wherein damage caused by leakage that has ingressed into an interior space of the machine is prevented.

To achieve this object in the case of an electric machine of the type mentioned in the introduction, it is provided according to the invention that the sealing device has a radial shaft sealing ring which surrounds the rotor and which delimits a reservoir for coolant leakage.

With the radial shaft sealing ring, the ingress of coolant leakage into the interior space of the electric machine can be reliably prevented. This allows the reservoir to be arranged in the housing of the electric machine, whereby the reservoir can be emptied in self-acting or automatic fashion. The emptying of the reservoir during maintenance is thus eliminated. The machine can thus be operated without maintenance, resulting in a cost saving.

Radial shaft sealing rings are used in a manner known per se to seal off rotating shafts with respect to the surroundings. A radial shaft sealing ring normally has an outer shell composed of an elastomer material, in which there is embedded a stiffening ring composed of metal. A seal that makes contact with the rotating shaft is situated on the inner radius of the shaft sealing ring.

A further advantage of the invention consists in that, with the arrangement of the reservoir in the housing, structural space can be saved in relation to a separate reservoir.

It is to be noted that the cooling channel of the electric machine runs through a rotor shaft of the rotor. It is however also conceivable for the cooling channel to run through some other part of the rotor, for example through a rotor body of the rotor.

The sealing device is preferably configured to seal off the rotor in a radial direction and an axial direction. This prevents coolant from escaping from the cooling channel and passing, for example, into a bearing of the rotor shaft. The sealing in a radial direction may be implemented by means of the radial shaft sealing ring. The sealing in an axial direction may be implemented by means of a slip ring seal, which likewise belongs to the sealing device.

The reservoir may be formed between the radial shaft sealing ring and a housing of the electric machine. In particular, the reservoir may be formed between the radial shaft sealing ring and a cover that closes the housing in an axial direction.

The cover may for example close off an opening of the housing, into which opening the rotor is inserted in an axial direction during the assembly of the electric machine. It is thus possible for an existing free space to be utilized for the reservoir, such that no additional structural space is required. As an alternative to this, the reservoir may also be formed between the radial shaft sealing ring and a part of the housing other than the cover.

The cover is preferably produced by way of a casting process. In this way, large unit quantities of the cover can be produced inexpensively. The cover may preferably be produced from an aluminium alloy, as a result of which its mass is particularly low. As an alternative to this, the cover may also be produced from a plastic, or as a deformed metal sheet.

One refinement of the invention provides that the radial shaft sealing ring is provided with a grease filling. This grease filling reduces the friction between the radial shaft sealing ring and the rotor and thus also reduces the wear of the seal. The sealing action of the radial shaft sealing ring is thus also improved.

Provision may also be made for the radial shaft sealing ring to be of dry-running configuration. In the case of a dry-running seal, there is no hydrodynamic sliding film, and therefore a sufficient sealing action is ensured in all operating states.

The above-stated objective is furthermore achieved by means of a drivetrain for a vehicle, which drivetrain has an electric machine according to the invention. The drivetrain may additionally have a gearbox coupled to the electric machine and/or an inverter connected to the machine, by means of which inverter a multi-phase AC voltage required for the operation of the electric machine can be provided.

The object is furthermore achieved by means of a vehicle that has a drivetrain of said type.

The object is furthermore achieved by way of a method for operating an electric machine according to the invention. The machine has a housing, in which a stator and a rotor, which is rotatable relative to the stator, are accommodated, a cooling device with a cooling channel through which a coolant can flow and which extends from an inlet, through the housing and through the rotor, to an outlet, and a sealing device for sealing off the rotor with respect to an interior space of the housing.

The method according to the invention is distinguished by the fact that a reservoir for coolant leakage is delimited by a radial shaft sealing ring that surrounds the rotor.

The advantages and details discussed in conjunction with the description of the electric machine self-evidently also apply analogously to the method according to the invention.

The invention will be discussed below on the basis of an exemplary embodiment with reference to the drawings. The drawings are schematic illustrations in which:

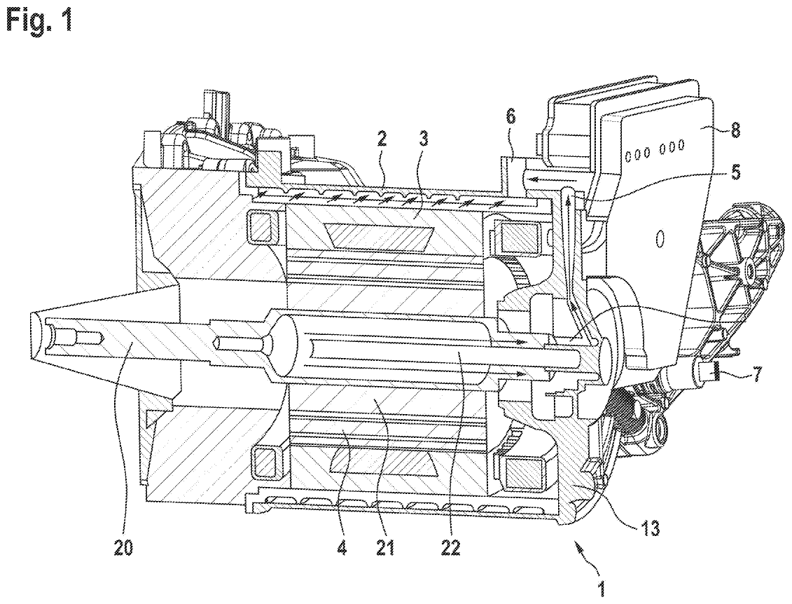

FIG. 1 shows a perspective sectional view of an electric machine according to the invention;

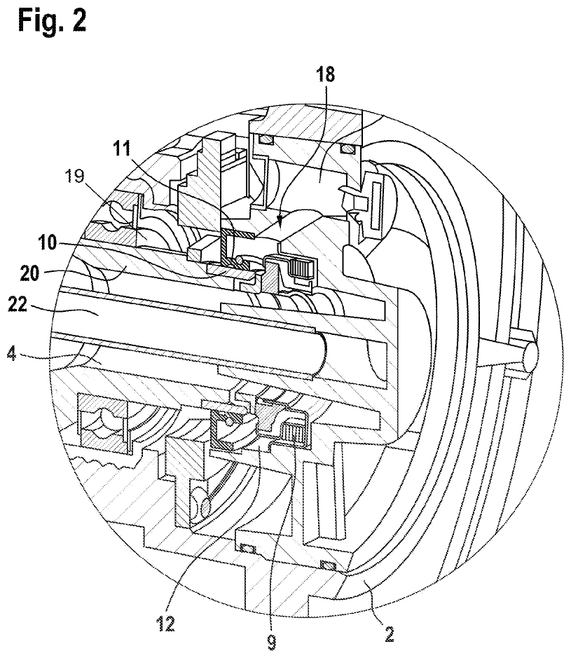

FIG. 2 shows an enlarged view of the right-hand end of the rotor shaft in FIG. 1;

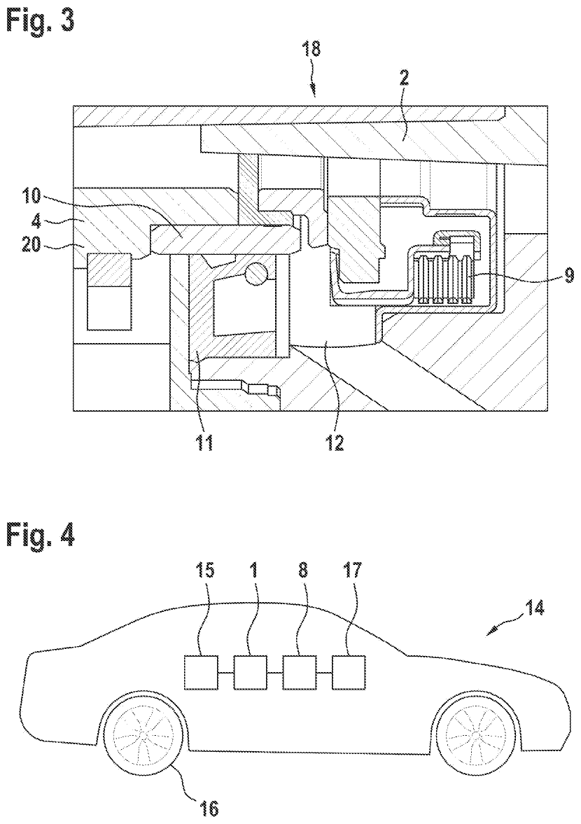

FIG. 3 shows a detail of the sealing device; and

FIG. 4 shows a vehicle according to the invention.

The electric machine 1 shown in a perspective sectional view in FIG. 1 belongs to the drive of a vehicle. The electric machine 1 may alternatively also have some other function.

The electric machine 1 comprises a housing 2 with an interior space 19 (see FIG. 2), in which a stator 3 and a rotor 4, which is rotatable relative to the stator 3 and which has a rotor shaft 20, are accommodated. The rotor shaft 20 is enclosed by a cylindrical rotor body 21. The electric machine 1 furthermore comprises a cooling device with a cooling channel 5 through which a coolant can flow and which extends from an inlet 7, through the housing 2, to an outlet 6.

The inlet 7 and the outlet 6, which may also be interchanged with one another, are connected via coolant lines (not illustrated) to a pump, such that the coolant is conveyed in a circuit. The coolant dissipates heat that is generated during the operation of the electric machine 1.

It can be seen in FIG. 1 that the cooling channel 5 extends through the housing 2 proceeding from the inlet 7. The coolant flows through a cooling pipe 22 (also referred to as a “lance”) into the hollow rotor shaft 20 of the rotor 4. At the end of the cooling pipe 22, the flow direction of the coolant is reversed, following which the coolant flows out of the rotor shaft 20 along an inner wall of the rotor shaft 20 past a sealing device 18 (see FIG. 2) and passes onward to the outlet 6.

On the outside of the housing 2, there is arranged an inverter 8 that provides the multi-phase AC voltage required for the operation of the electric machine 1.

FIG. 2 is a sectional view and shows the right-hand end of the rotor shaft 20 illustrated in FIG. 1. The sealing device 18 serves for sealing off the rotor shaft 20 in a radial direction and an axial direction with respect to the housing 2. In particular, the sealing device 18 serves for sealing off the rotor shaft 20 with respect to the interior space 19 of the housing 2, in which the stator 3 is accommodated. The sealing prevents coolant from passing into the interior space 19 and leading, for example, to corrosion of the windings of the stator 3 therein.

The sealing device 18 comprises a slip ring seal 9 and a radial shaft sealing ring 11. The slip ring seal 9 is arranged in an axial direction between the free end (on the right in FIG. 2) of the rotor shaft 20 and a section of the housing 2. The slip ring seal 9 seals off the rotor shaft 20 axially.

The end of the rotor 4 is enclosed by a sleeve 10 composed of hardened high-grade steel. The sleeve 10 is enclosed by a radial shaft sealing ring 11, which seals off the rotor shaft 20 radially with respect to the interior space 19 of the housing 2. The radial shaft sealing ring 11 is provided with a grease filling and is configured as a dry-running radial shaft sealing ring 11.

The sealing device 18 has the property that, in a particular direction of rotation of the electric machine, which is assigned to reverse travel of the vehicle, the abovementioned technical leakage occurs. Said technical leakage however involves only a small volume of a few millilitres.

In the sectional view of FIG. 2 and in the enlarged view of FIG. 3, which shows a detail of the sealing device 18, it can be seen that an encircling free space is formed between the slip ring seal 9, the radial shaft sealing ring 11 and that section of the housing 2 which surrounds the seals. Said free space, in particular its lower region in the installed state, serves as a reservoir 12 for the coolant leakage. If the technical leakage occurs as a result of the operation of the electric machine 1, in particular during reverse travel, said leakage collects in the reservoir 12.

In the event of a reversal of the direction of rotation, said coolant leakage is supplied back to the coolant circuit via the sealing device 18. The reservoir 12 is thus emptied again if the rotor 4 is rotated in the direction that is opposite to the first direction.

The housing 2 is closed at its axial side by a cover 13. In the exemplary embodiment illustrated, the cover 13 is composed of an aluminium alloy and is produced by injection moulding.

In summary, coolant leakage that occurs during rotation of the rotor 4 in the first direction of rotation is collected in the reservoir 12, and said leakage is conveyed out of the reservoir 12 again by means of the slip ring seal 9 during rotation of the rotor 4 in an opposite, second direction of rotation.

FIG. 4 shows a vehicle 14 with a drivetrain that comprises the electric machine 1. The electric machine 1 is coupled via a gearbox 15 to a wheel 16 of the vehicle 14. The electric machine 1 is additionally electrically connected to an inverter 8. The battery 17 provides a DC voltage, which is converted by means of the inverter 8 into an AC voltage for the operation of the electric machine 1.

### LIST OF REFERENCE DESIGNATIONS

1 Electric machine
2 Housing
3 Stator
4 Rotor
5 Cooling channel
6 Outlet
7 Inlet
8 Inverter
9 Slip ring seal
10 Sleeve
11 Radial shaft sealing ring
12 Reservoir
13 Cover
14 Vehicle
15 Gearbox
16 Wheel
17 Battery
18 Sealing device
19 Interior space
20 Rotor shaft
21 Rotor body
22 Cooling pipe

1. An electric machine, comprising:
a housing, in which a stator and a rotor, which is rotatable relative to the stator are accommodated;
a cooling device with a cooling channel through which a coolant flows and which extends from an inlet, through the housing and through the rotor, to an outlet; and
a sealing device for sealing off the rotor with respect to an interior space of the housing,
wherein the sealing device has a radial shaft sealing ring which surrounds the rotor and which delimits a reservoir for coolant leakage.

2. The electric machine according to claim 1, wherein the sealing device is configured to seal off the rotor in a radial direction and an axial direction.

3. The electric machine according to claim 1, wherein the reservoir is formed between the radial shaft sealing ring and a cover that closes the housing in an axial direction.

4. The electric machine according to claim 3, wherein the cover is produced by way of a casting process.

5. The electric machine according to claim 3, wherein the cover is produced from an aluminium alloy.

6. The electric machine according to claim 1, wherein the radial shaft sealing ring is provided with a grease filling.

7. The electric machine according to claim 1, wherein the radial shaft sealing ring is of dry-running configuration.

8. A drivetrain for a vehicle, which has an electric machine according to claim 1.

9. A vehicle having a drivetrain according to claim 8.

10. (canceled)
